(19) United States
(12) Patent Application Publication
(10) Pub. No.: US 2026/0317184 A1
(43) Pub. Date: Oct. 15, 2026

(54) PROCESS FOR AMMONIA SYNTHESIS USING GREEN HYDROGEN AND METHOD FOR REVAMPING AN AMMONIA PLANT

(71) Applicant: CASALE SA, Lugano (CH)

(72) Inventors: Gabriele COLOMBO, Pregassona (CH); Raffaele OSTUNI, Lugano (CH); Michal Tadeusz BIALKOWSKI, Taverne (CH); Sergio PANZA, Como (IT); Chiara COFFANO, Lugano (CH); Fabio OLDANI, Cantello (VA) (IT)

(21) Appl. No.: 19/475,156

(22) PCT Filed: Feb. 2, 2024
(86) PCT No.: PCT/EP2024/052651

§ 371 Date: Oct. 14, 2025

(30) Foreign Application Priority Data
Apr. 19, 2023 (EP) 23168787.2

(51) Int. Cl. C01C 1/04; C01B 3/025; C25B 1/04; C25B 9/05; C25B 15/08

(52) U.S. Cl. CPC C01C 1/0482; C01B 3/025; C25B 1/04; C25B 9/05; C25B 15/081; C01B 2203/0211; C01B 2203/068; C01B 2203/1235

(57) ABSTRACT

Process for synthesis of ammonia wherein: ammonia make-up gas (containing hydrogen and nitrogen is reacted in an ammonia converter-under ammonia forming conditions thus obtaining an ammonia-containing effluent; a first hydrogen portion contained in the ammonia make-up gas is produced by reforming a hydrocarbon source in a reforming process; a second hydrogen portion contained in the ammonia make-up gas is produced separately from said reforming process, by using at least a renewable energy source; a part of said hydrogen produced in step (c) is stored in a hydrogen storage; hydrogen from said hydrogen storage is used to fully or partially replace said second hydrogen portion when said renewable energy source is fully or partially unavailable.

### FIELD OF APPLICATION

The present invention concerns the field of synthesis of ammonia.

### PRIOR ART

Ammonia is produced industrially by reacting a make-up gas containing hydrogen and nitrogen in a suitable molar ratio. The make-up gas is conventionally produced by reforming a hydrocarbon source, such as natural gas.

The production of the MUG typically involves a reforming process and a purification of the reformed gas. The purification typically includes shift conversion of CO to CO₂; CO₂ removal and methanation. The so-obtained purified gas is fed to a high-pressure ammonia synthesis loop via a main compressor.

In the ammonia synthesis loop, the make-up gas is reacted to form ammonia in a suitable ammonia converter. The hot ammonia-containing effluent of the ammonia converter is subject to a cooling and separation step obtaining liquid ammonia and a side stream containing unreacted hydrogen and impurities. Typically, a portion of said side stream is subjected to a hydrogen recovery process, and the so obtained recovered hydrogen is sent to a suction of said main compressor. Another portion of said side stream is reintroduced into the ammonia converter, typically with a circulator, thus forming the above-mentioned ammonia synthesis loop.

The nitrogen required for ammonia synthesis may be introduced during the reforming process, typically in an air-fired secondary reforming. In some cases, nitrogen may be added separately, e.g., when an air separation unit (ASU) is used.

To summarize, the industrial production of ammonia relies on the reforming of hydrocarbons to produce the necessary hydrogen. Reforming is typically a fuel-fired process involving considerable CO₂ emissions.

There is a fast-growing interest in reducing the carbon footprint of ammonia production. Applicable norms and regulations may introduce additional taxation in relation to the CO₂ emissions, e.g., by considering the amount of CO₂ per ton of ammonia produced. The CO₂ contained in combustion fumes may be captured but the related techniques are expensive and, most importantly, carbon dioxide capture does not avoid generation of CO₂ emissions in the process gases but represents just an ex-post remedy. A promising way to achieve this goal is the production of hydrogen with renewable energy sources.

Hydrogen produced with renewable energy is termed “green” hydrogen because it does not cause emissions of CO₂ in contrast with the conventional fuel-fired production by reforming. Hydrogen produced by combustion of fossil fuels is often termed “grey” hydrogen. The advantage of using green hydrogen is that no CO₂ is formed, and therefore there is no need for expensive capture and sequestration of carbon dioxide.

An example of a process of practical interest to produce green hydrogen is represented by electrolysis of water. The electrolysis of water requires electricity which may be produced with a renewable source leading to the production of green hydrogen with no release of CO₂ in the atmosphere.

The green hydrogen so produced can be injected in an existing plant typically at the suction of the syngas compressor machine, or directly in the synthesis loop in addition to the grey hydrogen increasing the plant production, decreasing the specific hydrocarbon consumption of the plant, and decreasing the relevant CO₂ footprint.

The production of green hydrogen from renewable energy sources is, however, typically subject to fluctuations. For example, a solar-powered production of hydrogen is obviously dependent on the availability of sunlight. In order to compensate for such fluctuations, a storage of green hydrogen can be provided. The storage may fully or partially replace the production of green hydrogen when the energy source is fully or partially unavailable, in order to maintain certain minimum flow of the green hydrogen to the ammonia production. Hydrogen storage is realized in a form of a fixed-volume reservoir whose hydrogen inventory is often controlled by gas pressure. A hydrogen storage in this form features certain rigidity, thus imposes certain minimum and maximum hydrogen inventory and consequently capital and operational cost.

A drawback of a rigid storage of the above type is that its capacity must be sufficiently high to ensure said contribution of green hydrogen as long as the process so demands. However, the provision of a high-capacity storage is usually cost-critical especially when green hydrogen fluctuations are broad and frequent. Fluctuations in the production of green hydrogen are undesired events because they change the load of the ammonia converter abruptly. This load change is considered potentially harmful for the converter itself and other equipment of the high-pressure synthesis loop if fluctuations exceed the mechanical and process limits of controlled and safe operation. For example, a fast variation of load may cause high gas velocity which can damage the internals of the converter or other items of the loop. A sudden pressure drop may result in a shock (“hammering”) and damage of the equipment. Also, if pressure changes are frequent and sufficiently large, the equipment may wear due to fatigue cycles. Similar phenomena may occur also in case of significant fluctuations of the operating temperatures.

EP 4 148 020 A1 discloses a method for controlling an ammonia plant according to the prior art.

### SUMMARY OF THE INVENTION

The invention aims to overcome the above drawbacks of the prior art. In particular, the present invention aims to provide a process for the synthesis of ammonia wherein the use of so-called green hydrogen, that is hydrogen made from at least a renewable energy source, is made more attractive compared to the current prior art.

The aim is reached with a process for the synthesis of ammonia wherein:
(a) ammonia make-up gas containing hydrogen and nitrogen is reacted in an ammonia converter under ammonia forming conditions thus obtaining an ammonia-containing effluent;
(b) a first hydrogen portion contained in the ammonia make-up gas is produced by reforming a hydrocarbon source in a reforming process;
(c) a second hydrogen portion contained in the ammonia make-up gas is produced separately from said reforming process, by using at least a renewable energy source, preferably a variable renewable energy source;
(d) a part of said hydrogen produced (i.e., that is being produced or that has been produced) in step (c) is stored in a hydrogen storage;
(e) hydrogen from said hydrogen storage is used to replace fully or partially said hydrogen produced in step (c) when said renewable energy source is fully or partially unavailable;
   said process comprising the following steps:
(f) assessing an expected flow rate of the hydrogen produced in step (c);
(g) adjusting a flow rate of the hydrocarbon source in step (b) so that a flow rate of the first hydrogen portion in said ammonia make-up gas is in a desired ratio with respect to said expected flow rate of step (f);
(h) detecting an actual amount, e.g., a filling level, of said hydrogen in said hydrogen storage;
(i) detecting an actual flow rate of hydrogen produced in step (c);
(j) adjusting a flow rate of the hydrogen from said hydrogen storage depending on said actual amount detected in step (h) and on said actual flow rate detected in step (i).

The invention comes from the finding that a flexible operation of the process-in particular, by adjusting a flow rate of the hydrocarbon source and a flow rate of the hydrogen from said hydrogen storage based on selected criteria-allows to achieve surprising advantages in terms of reduced storage space of the hydrogen storage and reduced mechanical stresses in the plant equipment.

A reduced storage volume involves minor capital costs with respect to traditional hydrogen storages that, working with rigid parameters, must be designed to store considerable amounts of hydrogen.

On the other hand, infrequent variations of the front-end parameters preserve the installed equipment from being operated in a cyclic mode that would affect its mechanical reliability. As an example, without introducing significant changes of temperature and pressure in the reforming process, of flow rate through air or gas compressors, and pressure of the ammonia synthesis loop, the present process can reduce overall mechanical stresses, and hence achieves a safe and long-term operation of the equipment.

These advantages are possible in spite of broad and frequent fluctuations of the green hydrogen flow rate that are unavoidable in the production of hydrogen with renewable energy sources, specifically with variable renewable energy sources. In the present description “variable” means that the renewable energy source(s) provide(s) amounts of energy that may be subject to change as a function of time.

Also, it is an object of the present invention a method for revamping a plant for the synthesis of ammonia. Said plant to be revamped comprises a reforming front-end for the generation of an ammonia make-up gas by reforming a hydrocarbon source, and an ammonia synthesis loop including an ammonia converter. Said method for revamping the plant comprises the following steps:
(I) providing a green hydrogen producer device, such as a water electrolyser, using a renewable energy source, and a line arranged to feed green hydrogen from said green hydrogen producer device to the ammonia converter under pressure;
(II) providing a hydrogen storage, an input line arranged to feed the green hydrogen to the hydrogen storage, and an output line arranged to feed hydrogen from said hydrogen storage to the ammonia converter;
(III) updating a process management system of said plant for implementing said process.

### DESCRIPTION OF THE PREFERRED EMBODIMENTS OF THE PRESENT INVENTION

The hydrocarbon source 1 may be natural gas.

According to an embodiment, said reforming process 100 includes a step of desulphurization of the hydrocarbon source 1 followed by a step of primary reforming 3 in a fired furnace and a step of secondary reforming 4 with air, both in presence of steam.

According to another embodiment, said reforming process 100 includes a step of desulphurization of the hydrocarbon source 1 followed a step of autothermal reforming (ATR), possibly without pre-reforming, in an adiabatic reactor. A typical steam to carbon ratio in the ATR may be lower than 2, preferably comprised from 1.4 to 1.95. According to still another embodiment, the steam to carbon ratio in the ATR may be equal to or higher than 2, e.g., comprised from 2 to 3.5.

Said step of autothermal reforming is preferably fed with oxygen or oxygen-enriched air. To such purpose a stream of oxygen (O₂) obtained—together with hydrogen 19—in step (c) by electrolysis of water W may be used. An additional source of oxygen for autothermal reforming, e.g., an air separation unit (ASU; 31), may also be used in the present process.

Preferably, a purification 6 of the reformed gas may include CO shift, CO₂ removal and methanation.

A particularly preferred process to produce the hydrogen 19 in step (c) is electrolysis of water W. Preferably, said electrolysis of water W, more preferably pressurized alkaline electrolysis, is operated by solar energy SE and/or by wind energy WE, in particular such energy being produced through a photovoltaic power plant 104 and/or a wind turbine power plant 105, respectively, connected to the electrolyser. The photovoltaic power plant 104 and/or the wind turbine power plant 105 may be a standalone plant or may connected to an electric grid.

According to a preferred embodiment, said process further comprises the following steps:
(k) storing part of the electrical energy produced by said renewable energy source (SE, WE) in an electric storage battery 46; and
(l) producing said second hydrogen portion 19 with electricity stored in said electric storage battery 46, when said renewable energy source SE, WE is fully or partially unavailable.

According to another embodiment, a stream of oxygen (O₂) obtained—together with hydrogen 19—in step (c) by electrolysis of water W may be fed to an ATR 32 or to a secondary reformer 4 of the reforming front-end 100 through an oxygen feed line 42. Preferably, said stream of oxygen (O₂) is compressed in an oxygen compressor 44 and fed to an oxygen storage 106. Oxygen from said oxygen storage 106 is fed to the ATR 32 or to the secondary reformer 4 preferably in an amount that will not exceed the design temperature of the ATR or secondary reformer, or of heat recovery exchanger(s) of the cooling stage 5 that is/are positioned downstream of said ATR 32 or secondary reformer 4.

According to an embodiment, the renewable energy source is or comprises a biomass. Preferably, said hydrogen 19 is produced in step c) by a step of conversion of said biomass to a hydrogen-containing gas followed by a step of purification of said hydrogen-containing gas.

Biomass is widely considered a renewable form of energy because its energy comes from the sun. Biomass can be converted to hydrogen with a thermochemical process or a biological process such as fermentation. Preferred thermochemical processes include gasification, partial oxidation, and steam reforming. The source biomass is preferably a vegetable biomass, more preferably a lignocellulosic biomass. In a preferred embodiment, a biomass-to-hydrogen process includes gasification of such biomass, preferably a vegetable biomass.

A gasification process with oxygen converts biomass to a hydrogen-containing gas and further followed by purification of the hydrogen-containing gas in hydrogen and separation of CO₂. H₂ from biomass creates CO₂ emissions, but these CO₂ emissions are acceptable because they are carbon-neutral. This is because the vegetable material used as biomass source captures almost the same amount of CO₂ through photosynthesis while growing as it releases when biomass is burned.

Biomass gasification is related to the logistics of collecting biomass-the feedstock of the gasification-from one or multiple locations and conveying it to a location for gasification. Moreover, biomass storage requires significant storage space (land) hence only a limited amount of biomass can be stored where gasification is performed. As a consequence of such logistics and space constraints, the availability of feedstock to the gasification may be impacted and gasification may suffer time variation of the flow rate of biomass to the gasifier. Consequently, also the flow rate of hydrogen produced therefrom may be variable over time.

Preferably, an adjustment frequency of step (g) is smaller than an adjustment frequency of step (j). More preferably the adjustment frequency of step (g) may be at least ten times, more preferably at least fifty times, even more preferably at least hundred times, smaller than the adjustment frequency of step (j).

Even more preferably, step (g) is a long-term adjustment and step (j) is a short-term adjustment.

A long-term adjustment may be performed at time intervals comprised from 4 days to 7 weeks, preferably comprised from 5 days to 6 weeks, more preferably comprised from 6 days to 4 weeks (e.g., of 1 week, 2 weeks or 3 weeks).

A short-term adjustment may be performed at time intervals comprised from 1 minute to 28 hours, preferably comprised from 10 minutes to 26 hours, more preferably comprised from 20 minutes to 24 hours (e.g., of 30 minutes, 1 hour, 12 hours or 18 hours).

In step (g) said adjustment is preferably performed with a mild ramp change, i.e., over a time period of at least 3 hours, e.g., from 3 hours to 24 hours, preferably from 4 hours to 18 hours, more preferably from 5 hours to 12 hours, even more preferably from 6 hours to 10 hours, e.g., from 7 hours to 9 hours. Flow rates of air to the optional secondary reforming and of fuel to the optional primary reforming may also be varied with the same ramp change to maintain the necessary operative parameters.

The desired ratio in step (g) is preferably such that the flow rate of the first hydrogen portion in the ammonia make-up gas is inversely proportional with respect to said expected flow rate of step (f).

According to an embodiment, step (f) is or comprises a calculation of said expected flow rate from detected flow rates of said hydrogen 19 produced in step (c) in a past performance of said process. Said calculation is or comprises an average, a weighted average, or a rolling average (or mean moving average) of said detected flow rates over a predetermined time lapse. A rolling average is particularly preferred. The predetermined time lapse may cover the same time intervals as the long-term adjustment defined previously.

According to a possible embodiment, said rolling average may be calculated using weighted detected flow rates. E.g., the detected flow rates of a most recent past performance of said process (for example, of the previous day or previous two days) may have a higher weight with respect to the detected flow rates of a less recent past performance of said process (for example, of one or two week(s) before).

According to another embodiment, step (f) comprises a forecast based on estimated electrical energy 21 generated through the renewable energy source SE, WE in a given geographical area, in particular the geographical area where the process is performed. As an example, such estimation of the generated electrical energy 21 may be based on a previous or historical exploitation of the renewable energy source SE, WE, and/or on previous or historical weather data (solar irradiation, wind speeds, . . . ) in the given geographical area. Weather data have, in fact, a direct influence on the generation of electrical energy.

According to still another embodiment, step (f) comprises a forecast based on costs for electricity with respect to production costs. Preferably, said step (f) is trigger/signal based on a market pricing of electricity available with a forecasting mechanism (e.g., on short term such as 1-3 days, or on a long term such as 1-3 weeks).

Preferably, additional nitrogen 22 may be mixed to the ammonia make-up gas 7 upstream of the ammonia converter 15 to adjust a hydrogen to nitrogen (H/N) molar ratio for the synthesis of ammonia. Preferably, said additional nitrogen 22 is mixed with the hydrogen produced in step (c) at a mixing point or area 30 along a green hydrogen feed line 25, wherein the green hydrogen feed line 25 connects an electrolyser 102 and/or the hydrogen storage 103 to the reforming front-end 100, to the main compressor 11 or to the ammonia synthesis loop 101. Said H/N molar ratio is preferably comprised from 2.9 to 3.1. At least part (for example: all) of said additional nitrogen 22 may be obtained by cryogenic air separation, or pressure swing absorption (PSA), or by a dedicated air separation unit based on selective adsorption (a N2 PSA unit), followed by a purification step to remove residual oxygen.

According to a preferred embodiment, said additional nitrogen 22 is mixed to a stream of air 9 feeding the reforming front-end 100 upstream of an air compressor 10 to adjust a hydrogen to nitrogen molar ratio for the synthesis of ammonia. Said H/N molar ratio is preferably comprised from 2.9 to 3.1. Said hydrogen 19 produced in step (c) may be fed to the ammonia converter 15 via a main compressor 11 or via a dedicated compressor 29. More preferably, at least part (for example: all) of said additional nitrogen 22 is or comprises a tail gas of a nitric acid production process.

Preferably, said additional nitrogen 22 or said tail gas is compressed by said air compressor 10. According to another embodiment, said additional nitrogen 22 or said tail gas is compressed by the dedicated compressor 23.

According to an embodiment, the electrolyser 102 and/or the hydrogen storage 103 may be connected to an inlet line (suction side) of the main compressor 11, via a green hydrogen feed line 25.

According to other possible embodiments, the electrolyser 102 and/or the hydrogen storage 103 may be connected to the reforming front-end 100 (preferably downstream of the reforming stage(s) and upstream of the purification of the reformed gas 6), to an output line (discharge side) of the main compressor 11 or to the ammonia synthesis loop 101 via a green hydrogen feed line 25. In these latter cases, an additional compression may be necessary to bring the green hydrogen fed by the green hydrogen feed line 25 to an ammonia synthesis pressure.

According to another embodiment, the electrolyser 102 is connected to the hydrogen storage 103 through an input line 24 arranged to feed the green hydrogen under pressure to the hydrogen storage 103 by means of a hydrogen compressor 29. The hydrogen storage 103 has an output line 20 connected to a suction side of the hydrogen compressor 29.

With this loop connection between the hydrogen compressor 29 and the hydrogen storage 103 it is possible to maintain desired pressure values (that may be subject to change as a function of time, inter alia due to the actual or current amount of hydrogen stored in the hydrogen storage) in the hydrogen storage 103, and to feed the green hydrogen along the green hydrogen feed line 25 with the same hydrogen compressor 29, without making use of an additional compressor.

According to still other possible embodiments, the electrolyser 102 and the hydrogen storage 103 may be connected to a suitable location of the reforming front-end to feed green hydrogen, preferably upstream of the purification 6 of the reformed gas, even more preferably upstream of a methanator, upstream a CO₂ removal section, or upstream of a CO shift converter.

According to another embodiment, hydrogen obtained in step (c) is fed directly under pressure to the ammonia synthesis loop 101, without undergoing a compression stage performed by the hydrogen compressor 29. In this embodiment, a hydrogen compressor 29 may be located on a dedicated side line to feed hydrogen to the hydrogen storage 103.

According to a further embodiment, nitrogen required to adjust a hydrogen to nitrogen (H/N) molar ratio for the synthesis of ammonia may obtained by adjusting a flow rate of air 9 to an air compressor 10 feeding the reforming front-end 100. According to this embodiment an excess of nitrogen with respect to the hydrogen to nitrogen (H/N) ratio required by the ammonia synthesis stoichiometry is introduced in the reforming process 100. The flow rate of air 9 is chosen so that this excess of nitrogen results in the stoichiometric H/N molar ratio for the synthesis of ammonia once the hydrogen produced in step (c) is mixed with the ammonia make-up gas 7.

Preferably, said first hydrogen portion is introduced into said ammonia synthesis loop 101 with at least one from among said hydrogen 19 produced in step (c) and said hydrogen 20 from said hydrogen storage 103.

According to a preferred embodiment, said reforming process includes reforming the hydrocarbon source 1 and purification 6 of the so obtained reformed gas, thereby obtaining the ammonia make-up gas; feeding the ammonia make-up gas, to said ammonia converter 15 via the main compressor 11; said second hydrogen portion 19 being fed to the ammonia converter 15 via that same main compressor 11 or via a dedicated compressor 29. Said additional nitrogen 22 (optional) may be fed to the ammonia converter 15 via one or more dedicated compressor(s) 23, or first via an air compressor 10 and then through said main compressor 11.

Preferably, the hydrogen storage 103 is maintained at a pressure of at least 50 bar, preferably at a pressure comprised from 50 bar to 250 bar, more preferably comprised from 60 bar to 200 bar. The hydrogen may be stored under pressure in one or more suitable hydrogen storage vessels. Hence a hydrogen compressor 29 may be foreseen to elevate hydrogen pressure from electrolysis above the minimum pressure of the storage.

According to a preferred embodiment, a part of the hydrogen produced in step (c) is sent to the hydrogen storage 103 by means of a hydrogen compressor 29. Hydrogen stored in the hydrogen storage 103 feeds a suction side of the hydrogen compressor 29 so that such compressor maintains desired pressure values in the hydrogen storage 103 and feeds the hydrogen 19 to be contained in the ammonia make-up gas 7.

According to another preferred embodiment, a hydrogen compressor 29 is positioned downstream of the electrolyser 102 and upstream of the hydrogen storage 103. Preferably, a green hydrogen output line 20 feeds part of the hydrogen stored in the hydrogen storage 103 to a suction side of the hydrogen compressor 29. Desired pressure values in the hydrogen storage 103 are thus maintained. Consequently, hydrogen is stored in a cost-and space-effective way and is delivered at a higher pressure than the front-end operating pressure.

According to an embodiment, the hydrogen storage 103 has a maximum capacity of 1-week average production, preferably of 2-days average production, more preferably of 1-day average production, of said hydrogen 19 produced in step (c).

In a typical embodiment, said second hydrogen portion 19 produced with renewable energy accounts for up to 50% of the hydrogen contained in the ammonia make-up gas 7, preferably from 1% to 50%, more preferably from 2% to 35%, even more preferably from 3% to 25%, still more preferably from 5% to 15%. However, in some embodiments the green hydrogen may account for a greater part (more than 50%) of the total hydrogen.

In a possible embodiment, the ammonia converter 15 is part of an ammonia synthesis loop 101. The ammonia synthesis loop 101 may include the ammonia converter 15, a make-up gas preheater, a cooling and separation stage 16 and a circulator 13. Preferably, the green hydrogen feed line 25 is connected to the ammonia synthesis loop 101 between the circulator 13 and the converter 15, more preferably at a discharge of circulator 13.

In other embodiment, the green hydrogen feed line 25 is fed downstream of the ammonia converter 15, e.g., between the ammonia converter 15 and the cooling-separation stage 16 or between the cooling-separation stage 16 and the circulator 13.

Preferably, in the method for revamping, said step (III) comprises uploading a computer program in an internal memory of a process management system 26 of said plant, said computer program comprising software code portions suitable for implementing said process, wherein said software code portions are executed by said process management system 26.

According to another embodiment of the method for revamping, said green hydrogen producer device is a water electrolyser, and said method comprises providing a line 42 arranged to feed a stream of oxygen (O₂) obtained by said water electrolyser from said water electrolyser to a reforming front-end 100, preferably to an ATR 32 or a secondary reformer 4 of the reforming front-end 100.

### Advantages of the Present Invention

According to an advantageous aspect, the process of the present invention allows to reduce the size of the hydrogen storage and to avoid wasting or venting a significant portion of the fluctuating green hydrogen.

Advantageously, a hydrogen storage used in the process of the present invention may be dimensioned up to 10 times, preferably up to 20 times, more preferably up to 30 times, smaller than a hydrogen storage of a rigid plant.

Advantageously, the present method for revamping preserves use of an existing front-end. Possible hardware modifications of the ammonia synthesis section are minor in impact and costs.

Also, the present method for revamping advantageously allows to operate existing equipment of an ammonia plant within the constraints of the original design, avoiding any cyclic operation and therefore mechanical fatigue issue, despite having to accommodate a significant additional amount of variable green hydrogen.

Advantageously, nitrogen required to obtain a stoichiometric hydrogen to nitrogen (H/N) ratio for ammonia synthesis may obtained by modifying the flow rate of air to the air compressor, so that an excess of nitrogen in the ammonia make-up gas is obtained with respect to the H/N ratio required by the ammonia synthesis stoichiometry. The air flow rate is chosen so that this nitrogen excess results in a stoichiometric H/N ratio once the green hydrogen is mixed with the ammonia make-up gas through the feed line. In this way, costs related to an additional nitrogen source are decreased or removed.

Advantageously, feeding green hydrogen and optionally additional nitrogen at the suction of the main compressor allows to reduce the investment cost for newly installed compressors.

Advantageously, the presence of a hydrogen compressor allows to store hydrogen in a cost-and space-effective way, and to deliver hydrogen at a higher pressure than the front-end operating pressure. In some embodiments, the hydrogen compressor may be set to deliver green hydrogen at the pressure of the ammonia synthesis loop, or at a pressure higher than the pressure of the ammonia synthesis loop.

Advantageously, the presence of a source of additional nitrogen is that such additional nitrogen does not go through the reforming front-end 100 and hence avoids fluctuations at the outlet temperatures of the reformers. This is because the flow rate of air to the air compressor must not change to maintain the desired H/N ratio according to the fluctuating amount of the hydrogen produced in step (c).

Advantageously, feeding green hydrogen and optionally additional nitrogen directly in the ammonia synthesis loop leads to smaller variations in operating conditions due to green hydrogen fluctuations (since the mass flow of gas circulating in the loop is typically 2-4 times the mass flow delivered by the front-end), decreased energy consumption of the main compressor and therefore decreased CO₂ emissions (if the syngas compressor is driven by steam generated in the front-end using fossil feedstock).

Advantageously, feeding green hydrogen and optionally additional nitrogen at the discharge of the circulator avoids loading the refrigeration section of the ammonia synthesis loop with additional cooling duty. Also, temperature levels in the loop can be maintained while limiting the area of heat exchange to be installed in the loop gas-gas heat exchangers, and therefore limiting their cost.

Advantageously, variation of green hydrogen input to the ammonia synthesis loop is chosen so that the production rate of ammonia is maintained within a range of maximum deviation from the required overall average production.

Advantageously, pressurized alkaline electrolysis involves lower investment costs with respect to other electrolysis technologies, and a decreased power consumption and investment costs by avoiding a compression of green hydrogen starting from an atmospheric pressure.

Advantageously, pressure swing absorbers (PSAs) are more flexible and cost intensive units than alternative air separation technologies, leading to lower power consumption and investment cost.

Advantages of single-train cryogenic air separation units are higher ammonia production rates and lower investment cost with respect to other air separation units at the mentioned higher production rates.

Advantageously, the use rolling average values allows to obtain a useful set point of the front-end production rate, which avoids loss of ammonia production when the storage is empty or by power curtailment when the storage is completely full. Also, these values as set points require only information that is available to plant operators.

Advantageously, a part of green hydrogen may be used as fuel in reforming process. Any fluctuation in green hydrogen availability may be tackled by the reformer by adjusting the relative amount of green hydrogen fuel with respect to natural gas fuel, while maintaining a constant reforming temperature. As a result, no fluctuations are experienced by the process gas undergoing steam reforming, despite using fluctuating green hydrogen as fuel.

Advantageously, a hybrid process according to the present invention replaces at least part of grey hydrogen with green hydrogen, so that CO₂ emissions are decreased. Such decrease is two-fold: on one side minor amounts of CO₂ are generated in the flue gases of the reforming front-end and, on the other side, an overall reformer process gas (process syngas) and consequently also the CO₂ therein contained are reduced.

It is worth mentioning that another known technical strategy for reducing CO₂ emissions is electric reforming wherein fuel for generating reforming heat in the reforming front-end is replaced by electrical energy, so that no carbon dioxide-containing flue gases are generated. However, the amount of CO₂ in the process syngas (a majority) is left unchanged if the productivity of the reforming front-end remains the same. This is due to the fact that no green hydrogen is used to partly replace the grey hydrogen produced using electrical energy, so that same amounts of CO₂ are contained in the process syngas.

Advantageously, the process of the present invention allows to decouple the green hydrogen feed to the hydrogen storage and the ammonia synthesis process. This is due to the fact that ammonia synthesis does not only depend on the hydrogen flow rate feeding the storage, so that synthesis is made independent from the filling process of the hydrogen storage.

Advantageously, feeding additional nitrogen to an air compressor leads to a more stable operation of the air compressor in terms of flow rate compared to a dedicated compressor.

More precisely, when green hydrogen is available and added, additional nitrogen is usually needed and fed to the air compressor with the air required by the load of the reforming front-end. However, when green hydrogen is not available, additional nitrogen is not required and only the air needed by the reforming front-end is fed at a suction side of the compressor. In both conditions air compressor is fed with air and/or with additional nitrogen with a gas flow higher than 50% of the air flow required by reforming front-end operating at a load of 100%.

This leads to a preferred embodiment wherein the gas flow fed to the air compressor may be comprised from 50% to 115%, preferably comprised from 70% to 110%, more preferably comprised from 85% to 105%, even more preferably comprised from 97.5% to 102.5%.

According to another embodiment, when green hydrogen is available, additional nitrogen 22 may be needed and may be fed to the dedicated compressor 23 with a flow up to 100% of a maximum value of nitrogen flow rate. When green hydrogen is not available, additional nitrogen may not be required and there may be no gas flow to the dedicated compressor (flow: 0%). Hence, a dedicated compressor 23 may be subject to a flow variation from 0% to 100%.

### DESCRIPTION OF THE FIGURES

FIG. 1: simplified scheme of a first embodiment of the present invention;

FIG. 2: simplified scheme of a second embodiment of the present invention;

FIG. 3: simplified scheme of a third embodiment of the present invention;

FIG. 4: power availability from a photovoltaic power plant in a time period of about 200 hours, as discussed in the example;

FIG. 5: a mean moving average, calculated over a predetermined time lapse of two weeks, of the power profile shown in FIG. 4;

FIG. 6: hydrogen storage capacity of a rigid plant according to the prior art;

FIG. 7: required adjustments of a front-end load during the year according to the process of the present invention;

FIG. 8: resulting filling profile of a hydrogen storage used in the process of the present invention;

FIG. 9: enlargement of the dash-lined area shown in FIG. 8 at a time between 3000 H and 4000 H;

FIG. 10: simplified scheme of a fourth embodiment of the present invention;

FIG. 11: simplified scheme of a fifth embodiment of the present invention.

### DETAILED DESCRIPTION OF THE INVENTION

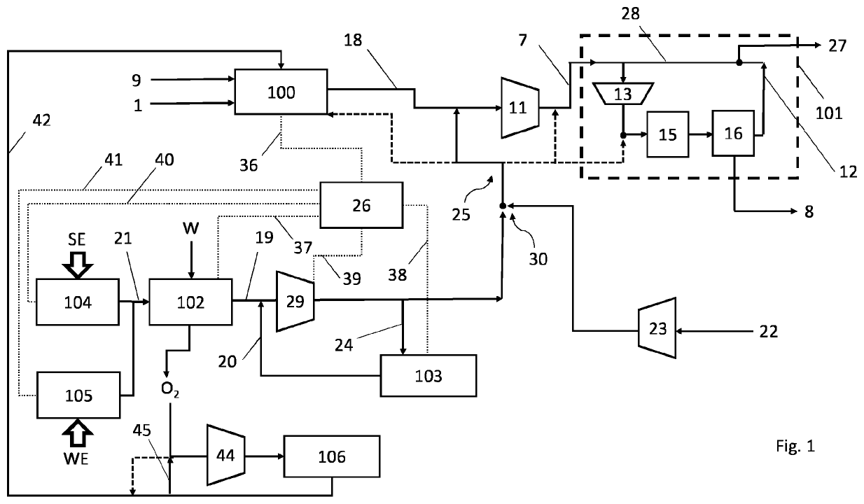

FIG. 1 is a simplified scheme of a preferred embodiment of the present invention wherein the main items are represented according to the following list of reference signs:
1 hydrocarbon source, such as natural gas
7 ammonia make-up gas
8 ammonia-containing effluent
9 air feed to reforming process
11 main compressor of the ammonia make-up gas 7
12 recycle gas
13 circulator
15 ammonia converter
16 cooling-separation stage
18 make-up gas from reforming process (reforming make-up gas)
19 hydrogen produced in step (c) or second hydrogen portion or green hydrogen
20 green hydrogen output line from hydrogen storage
21 electrical energy
22 additional nitrogen (optional)
23 dedicated compressor (optional)
24 green hydrogen input line in hydrogen storage
25 green hydrogen feed line
26 process management system
27 first portion (purge gas)
28 second portion
29 hydrogen compressor
30 mixing point or area
35 valve means
36 management line
37 management line
38 management line
39 management line
40 management line
41 management line
42 electrolyser oxygen feed line (optional)
44 oxygen compressor
45 oxygen output line
100 reforming process or reforming front-end
101 ammonia synthesis loop
102 electrolyser for production of hydrogen
103 hydrogen storage
104 photovoltaic power plant
105 wind turbine power plant
106 oxygen storage (optional)
SE renewable energy source, in particular solar energy
WE renewable energy source, in particular wind energy
W water
O₂ oxygen

With reference to FIG. 1, a hydrocarbon source 1 is desulfurized and steam reformed in a reforming front-end 100. The so obtained desulfurized and reformed gas is purified to obtain a purified syngas.

The required amount of nitrogen may be introduced with an air feed 9 routed to the reforming front-end 100 through an air compressor 10 to obtain an ammonia make-up gas 7 containing the purified syngas.

The ammonia make-up gas 7 is fed to an ammonia synthesis loop 101 by a main compressor 11. After pre-heating in a heat exchanger, the pre-heated ammonia make-up gas is reacted in an ammonia converter 15.

An effluent of the converter goes to a cooling and separation stage 16. From here, an ammonia-containing effluent 8 and a recycle gas 12 are separated.

The recycle gas 12 is split into a first portion 27 (purge gas) and a second portion 28. The first portion 27 is sent to a hydrogen recovery unit (HRU) where hydrogen is separated from other impurities, such as non-condensable gases. The second portion 28 is recirculated in the ammonia synthesis loop 101 via a circulator 13. The circulator 13 compensates for pressure drops maintaining circulation in the ammonia synthesis loop 101. The HRU may use a cryogenic system, a membrane-based system, or a PSA.

An electrolyser 102 is powered by at least a renewable energy source—i.e., solar energy SE and/or wind energy WE—producing electrical energy 21 for performing electrolysis of water W. Electrical energy 21 is produced through a photovoltaic power plant 104 and/or a wind turbine power plant 105. Electrolysis of water W produces hydrogen 19 and oxygen O₂. Such oxygen may be exported to the reforming front-end 100 through an electrolyser oxygen feed line 42. Said stream of oxygen O₂ may compressed in an oxygen compressor 44, fed to an oxygen storage 106, and then to the reforming front-end 100 in a suitable amount. The oxygen storage 106 has an oxygen output line 45 connected to a suction side of the oxygen compressor 44.

The electrolyser 102 may be connected to an inlet line of the main compressor 11, via a green hydrogen feed line 25. Alternatively (see dotted arrows), a green hydrogen feed line 25 may connect the electrolyser 102 to the reforming front-end 100, to an output line of the main compressor 11 or directly to the ammonia synthesis loop 101. In these latter alternatives, an additional compressor (not shown) may be necessary to bring the green hydrogen fed by the electrolyser 102 to an ammonia synthesis pressure or, as an alternative, the hydrogen compressor 29 may be used for such purpose (see below).

The electrolyser 102 is further connected to a hydrogen storage 103 through an input line 24 arranged to feed the green hydrogen under pressure to the hydrogen storage 103 by means of a hydrogen compressor 29. The hydrogen storage 103 has an output line 20 connected to a suction side of the hydrogen compressor 29. With this loop connection between the hydrogen compressor 29 and the hydrogen storage 103 it is possible to maintain desired pressure values in the hydrogen storage 103, and to feed the green hydrogen along the green hydrogen feed line 25 with the same hydrogen compressor 29, without making use of an additional compressor.

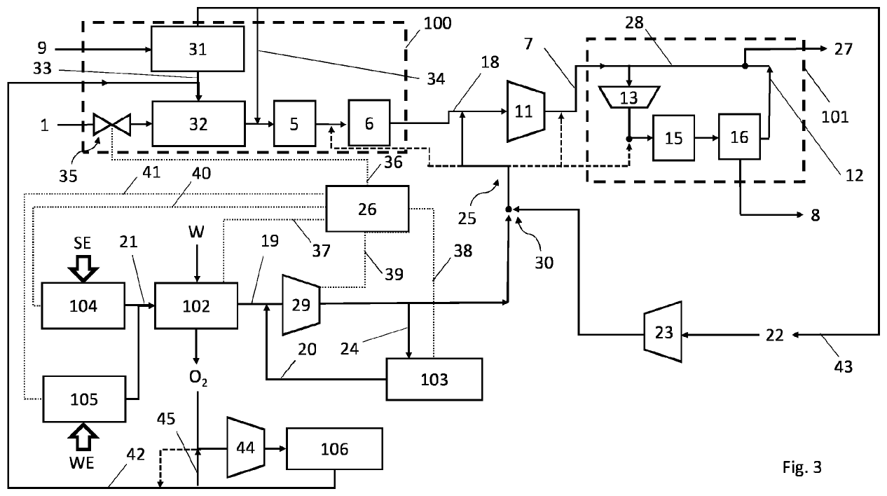

Additional nitrogen 22 may be fed to hydrogen feed line 25 by a dedicated compressor 23 to adjust a hydrogen to nitrogen molar ratio for the synthesis of ammonia. Such additional nitrogen 22 may be obtained with an air separation unit 31 (see e.g., FIG. 3) or pressure swing absorption (PSA).

A process management system 26 is functionally connected to the reforming front-end 100, to the electrolyser 102, to the hydrogen storage 103, optionally to the hydrogen compressor 29, to the photovoltaic power plant 104 and/or to the wind turbine power plant 105 through respective process management lines 36, 37, 38, 39, 40, 41 to manage the process for the synthesis of ammonia as follows.

The ammonia synthesis loop 101 receives the ammonia make-up gas 7 conventionally produced in the reforming front-end 100 together with the green hydrogen 19 of line 25. For example, the hydrogen from the electrolyser 102 may be about 10% of the overall hydrogen contained in the ammonia make-up gas 7.

Based on the availability (e.g., on the generated power) of the renewable energy source of the electrolyser 102, the hydrogen from the storage 103 may be used to partially or fully replace the production of said electrolyser 102. For example, assuming the electrolyser 102 uses solar energy SE, the stored hydrogen (withdrawn from the storage 103 through line 20) may be used during night time and/or cloudy conditions when the solar energy drops.

The use of the hydrogen storage is beneficial in terms of carbon dioxide emissions because it stores only green hydrogen.

According to the present process, firstly an expected flow rate of green hydrogen produced by the electrolyser 102 is assessed. This assessment may involve a calculation (e.g., a mathematical average) from detected flow rates of said green hydrogen 19 in a past performance of said process, and/or a forecast based on an estimated electrical energy 21 generated through the renewable energy source in a given geographical area.

A flow rate of the hydrocarbon source 1 is subsequently adjusted (e.g., through valve means 35 functionally connected to the process management system 26), so that a flow rate of the first hydrogen portion in said ammonia make-up gas 7 (and, more precisely, in the reforming make-up gas 18) is in a desired ratio with respect to said expected flow rate.

An actual amount, e.g., a filling level, of said green hydrogen in said hydrogen storage 103 and an actual flow rate of hydrogen produced in step (c) are also detected, and a flow rate of the green hydrogen 20 of the hydrogen storage 103 is adjusted depending on said actual amount and on said actual flow rate. The flow rates of air 9 and fuel for the reforming process may be varied correspondingly, or may be maintained constant instead.

More precisely, the flow rate of green hydrogen fed to the ammonia synthesis loop 101 may be set between a minimum and a maximum value, according to the actual amount (e.g., of the filling level) of the hydrogen storage 103. If the actual amount is greater than an upper threshold, a maximum amount of green hydrogen is fed. If the actual amount is smaller than a lower threshold, a minimum amount of green hydrogen is fed. If the filling level is between these thresholds, an intermediate amount of green hydrogen-comprised between the minimum amount and the maximum amount-is fed to the ammonia synthesis loop 101.

If, however, the amount of green hydrogen to be fed to the ammonia synthesis loop 101 is larger, or respectively smaller, than the amount produced in step (c), the difference is withdrawn from, or respectively routed to, the hydrogen storage 103.

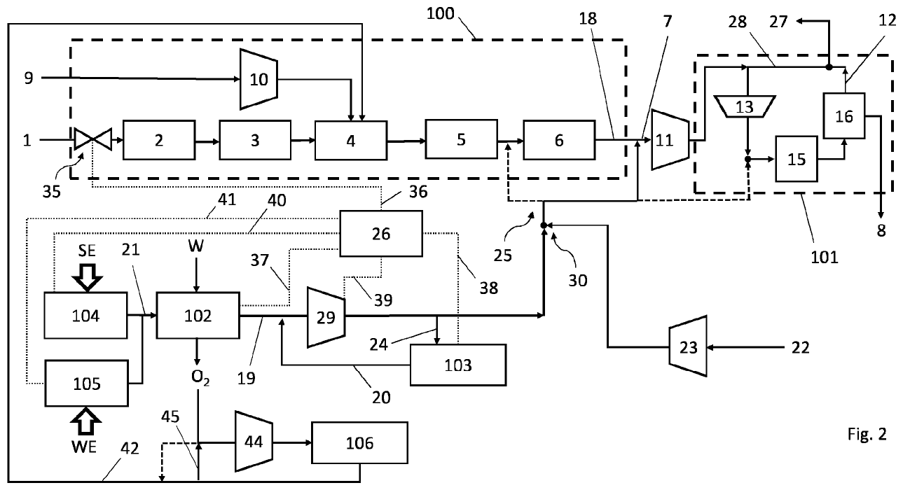

FIG. 2 shows another embodiment of the present process. Same reference signs as in FIG. 1 denote identical or corresponding technical features. Additionally, the following references are used:
2 desulfurization
3 primary reformer, such as a fired furnace
4 secondary reformer
5 cooling
6 purification of the reformed gas, preferably shift converter(s) and carbon dioxide removal
10 air compressor

The reforming front-end 100 is shown in a greater detail. The hydrocarbon source 1 goes—in sequence—through stages of desulfurization 2, primary reformer 3 and secondary reformer 4. The air feed 9 is routed to the secondary reformer 4 after compression in air compressor 10.

An effluent of the secondary reformer 4 is then subjected to a cooling stage 5, and such cooled effluent goes through shift converter(s) and carbon dioxide removal stages 6. One or more shift converters may be provided, for example a high-temperature shift converter followed by a low-temperature shift converter. Carbon dioxide removal may be performed for example by amine or carbonate solution washing, pressure swing adsorption (PSA) or another technique for removing CO₂ from a gas. The reforming make-up gas 18 is thus obtained.

FIG. 3 shows another embodiment of the present process. Same reference signs as in FIG. 1 and FIG. 2 denote identical or corresponding technical features. Additionally, the following references are used:
31 air separation unit (ASU)
32 autothermal reforming (ATR)
33 oxygen feed line from ASU to ATR
34 nitrogen feed line from ASU to ATR effluent
43 nitrogen feed line from ASU to mixing point or area

An alternative reforming front-end 100 is shown in a greater detail. A desulfurized hydrocarbon source 1 is reformed in an autothermal reforming stage 32. An effluent of the ATR then goes through a stage of purification of the reformed gas 6 to obtain a reforming make-up gas 18.

An air feed 9 is routed to an air separation unit 31 wherein air is separated in an oxygen stream and a nitrogen stream. The oxygen stream is fed to the ATR 32 through line 33, and the nitrogen stream is fed through line 34 between the ATR 32 and the stage of purification of the reformed gas 6 to provide the required amounts of nitrogen for ammonia synthesis.

Oxygen O₂ produced in the electrolyser 102 may also be fed to the ATR 32 through an electrolyser oxygen feed line 42.

A portion of the nitrogen stream separated in the air separation unit 31 may be fed to the mixing point or area 30 with a nitrogen feed line 43, preferably through the dedicated compressor 23, to provide additional nitrogen 22 for adjusting the hydrogen to nitrogen (H/N) molar ratio for the synthesis of ammonia.

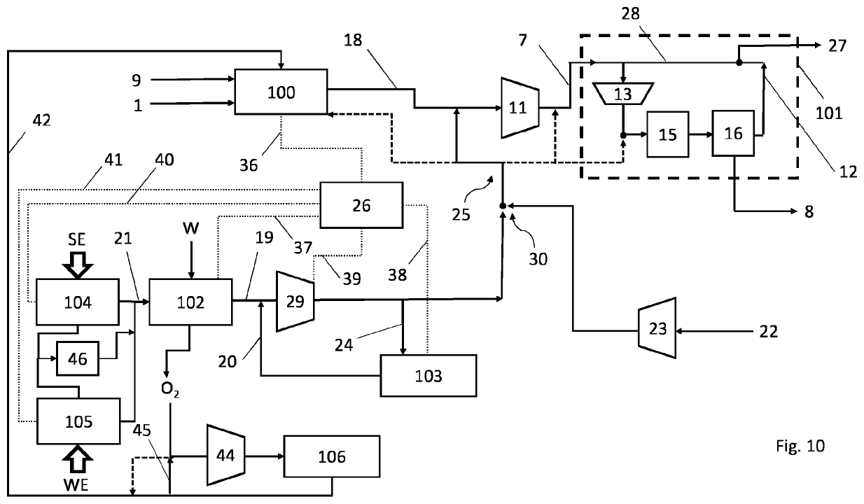

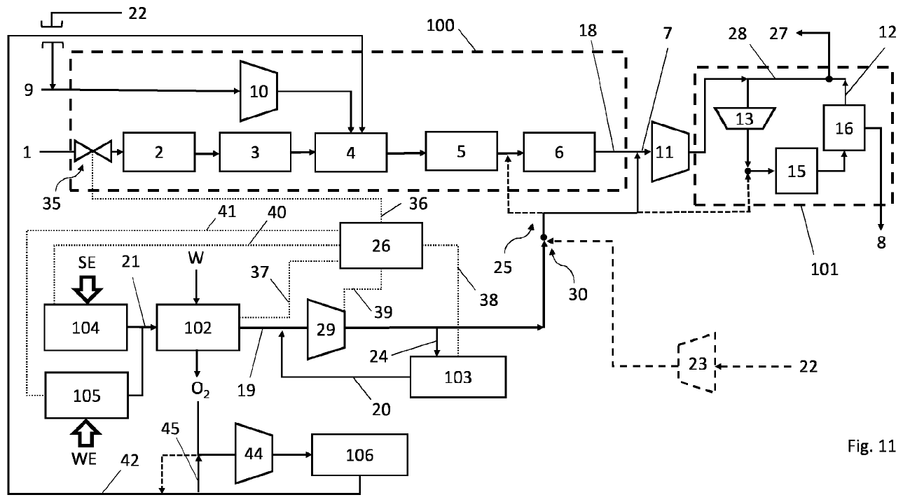

FIG. 10 shows an alternative embodiment of FIG. 1 comprising an electric storage battery 46 electrically connected to the renewable energy source(s) SE, WE, so that part of the electrical energy produced by said source(s) can be stored in the electric storage battery 46. In other words, the electric storage battery 46 is charged by the renewable energy source(s) SE, WE, e.g., when there is an over-production of electrical energy produced by said source(s) with respect to the energy required for the production of the second hydrogen portion 19.

The electric storage battery 46 is further electrically connected to the electrolyser 102 so that said second hydrogen portion 19 can be produced with electricity stored in said electric storage battery 46, e.g., when said renewable energy source SE, WE is fully or partially unavailable. This means that the electrolyser 102 may be powered by the electric storage battery 46, if so required.

FIG. 11 shows an alternative embodiment of FIG. 2 wherein additional nitrogen 22 is mixed to the stream of air 9 feeding the reforming front-end 100 in a position upstream of the air compressor 10. At least part of such additional nitrogen 22 may be or comprise a tail gas of a nitric acid production process.

FIG. 11 shows also another stream of additional nitrogen 22 compressed in the dedicated compressor 23 and directed to the mixing point or area 30. The dashed lines of the dedicated compressor 23 and of the connecting pipes mean that these parts are optional, so that the additional nitrogen 22 may be fed only by mixing to the stream of air 9.

The present invention will now be described in view of the following non-limitative example.

### Example

This example relates to an ammonia plant according to FIG. 1 wherein a second hydrogen portion (green hydrogen) corresponding to 10% of the hydrogen necessary for a total ammonia production of 1000 tonnes per day is used.

The green hydrogen is produced by water electrolysis using renewable power. In this example such power is delivered by a solar photovoltaic power plant 104 only. However, other tests (not shown) performed using wind energy or a combination of solar energy and wind energy provided results that are in line with the evidences obtained by using only a solar photovoltaic power plant 104.

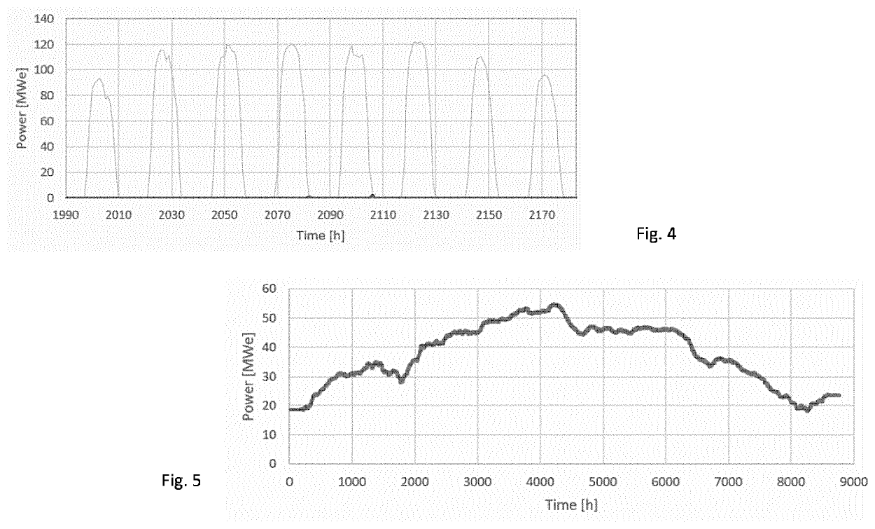

A representative sample of about 200 hours (approx. 8 days) of the power availability from the photovoltaic power plant 104 is given in FIG. 4.

The mean moving average (calculated over 337 h, i.e., two weeks) for this power profile is shown in FIG. 5. The resulting curve shows the average availability of green hydrogen during the year, therefore the seasonality of the power profile. As it can be seen, the power availability, and therefore the production of green hydrogen, about 2.5 times larger in summer (around 4000 hours) than in winter (around 0 and 9000 hours).

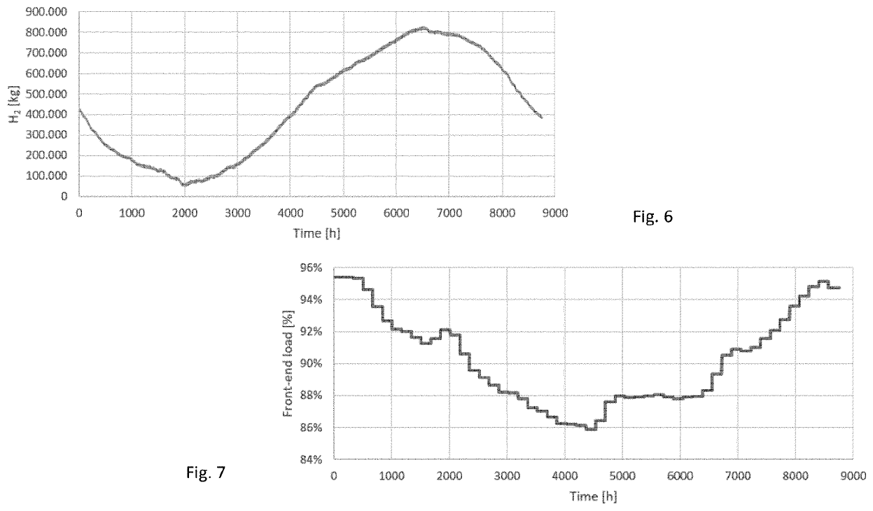

As a result, a traditional hybrid plant (a “rigid” plant) designed to accommodate the same input of green hydrogen, but not applying the flexible operation of present invention, would require a very large hydrogen storage of impractical size, with a maximum storage capacity of up to 825 tonnes of hydrogen required between hour 6000 and hour 7000 of operation of the plant, to operate at constant ammonia production rate and achieve the same objective of overall 10% of green hydrogen input. This filling profile of the H2 storage is shown in FIG. 6. FIG. 6 demonstrates that a large storage capacity is essential due to the seasonal imbalance of green hydrogen availability for a “rigid” plant.

In contrast, a hybrid plant operated according to the process of the present invention can use the same total amount of green hydrogen, delivered with the same profile of the case above, with a hydrogen storage size of only 24 tonnes of hydrogen, corresponding to 32 hours of average green hydrogen production.

The required adjustments—in step (g)—of the front-end load during the year is shown in FIG. 7.

The adjustments are in this case carried out with a weekly cadence, where the new set-point is determined to be equal to the rolling average of the green hydrogen availability of the previous 2 weeks. The resulting curve mirrors the seasonality of the power profile, and the yearly average load of the front-end is as expected about 90%.

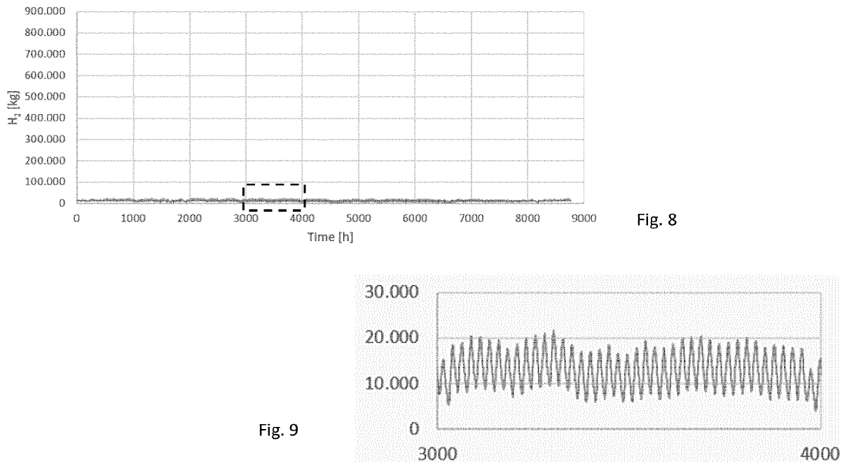

Thanks to the compensation of variability delivered by the front-end, the ammonia synthesis section only needs to operate with a flexibility in ammonia production rate of 5% of the total production, which is within the variability that the existing equipment can tolerate. The resulting filling profile of the hydrogen storage in shown in FIG. 8 and FIG. 9. FIG. 9 is a zoom of interval between 3000 h and 4000 h of FIG. 8. As it can be seen, the hydrogen storage is in this case only buffering the short-term (hours to days) fluctuations in green hydrogen availability, that the relatively small used flexibility of the ammonia synthesis loop is not able to absorb by adapting its load and ammonia production.

Overall, when comparing the production cost of the ammonia fraction produced with the 10% green hydrogen input, considering the investment cost of the green hydrogen production section and its operating costs (mainly electricity to power the electrolyzer(s)), the hybrid plant managed with the process of the present invention delivers a production cost more than three times cheaper than a “rigid” hybrid plant. This large difference is in fact mostly caused by the very large capacity of expensive hydrogen storage to be installed in the case of a rigid plant.

1. A process for the synthesis of ammonia wherein:
(a) ammonia make-up gas containing hydrogen and nitrogen is reacted in an ammonia converter under ammonia forming conditions thus obtaining an ammonia-containing effluent;
(b) a first hydrogen portion contained in the ammonia make-up gas is produced by reforming a hydrocarbon source in a reforming process;
(c) a second hydrogen portion contained in the ammonia make-up gas is produced separately from said reforming process, by using at least a renewable energy source;
(d) a part of said hydrogen produced in step (c) is stored in a hydrogen storage;
(e) hydrogen from said hydrogen storage is used to fully or partially replace said hydrogen produced in step (c) when said renewable energy source is fully or partially unavailable;
said process comprising:
(f) assessing an expected flow rate of the hydrogen produced in step (c);
(g) adjusting a flow rate of the hydrocarbon source in step (b) so that a flow rate of the first hydrogen portion in said ammonia make-up gas is in a desired ratio with respect to said expected flow rate of step (f);
(h) detecting an actual amount of said hydrogen in said hydrogen storage;
(i) detecting an actual flow rate of hydrogen produced in step (c);
(j) adjusting a flow rate of the hydrogen from said hydrogen storage depending on said actual amount detected in step (h) and on said actual flow rate detected in step.

2. The process according to claim 1, wherein an adjustment frequency of step (g) is smaller than an adjustment frequency of step (j), the adjustment frequency of step (g) being at least ten times smaller than the adjustment frequency of step (j).

3. The process according to claim 1. wherein step (g) is a long-term adjustment and step (j) is a short-term adjustment:
said long-term adjustment being performed at time intervals comprised from 4 days to 7 weeks; and
said short-term adjustment being performed at time intervals comprised from 1 minute to 28 hours.

4. The process according to claim 1, wherein step (f) is or comprises a calculation of said expected flow rate from detected flow rates of said hydrogen (19) produced in step (c) in a past performance of said process.

5. The process according to claim 1, wherein said calculation is or comprises a rolling average of said detected flow rates over a predetermined time lapse.

6. The process according to claim 1, wherein step (f) comprises a forecast based on estimated electrical energy generated through the renewable energy source in a given geographical area.

7. The process according to claim 1, wherein additional nitrogen is mixed to the ammonia make-up gas upstream of the ammonia converter to adjust a hydrogen to nitrogen molar ratio for the synthesis of ammonia; said hydrogen produced in step (c) being fed to the ammonia converter via a main compressor or via a dedicated compressor; at least part of said additional nitrogen being obtained by cryogenic air separation or pressure swing absorption.

8. The process according to claim 1, wherein additional nitrogen is mixed to a stream of air feeding the reforming front-end upstream of an air compressor to adjust a hydrogen to nitrogen molar ratio for the synthesis of ammonia; said hydrogen produced in step (c) being fed to the ammonia converter via a main compressor or via a dedicated compressor (29); at least part of said additional nitrogen being or comprising a tail gas of a nitric acid production process; said tail gas being compressed by said air compressor.

9. The process according to claim 1, wherein the hydrogen of step (c) is produced by electrolysis of water by pressurized alkaline electrolysis.

10. The process according to claim 1, wherein said electrolysis of water is operated by solar energy and/or by wind energy, in particular through a photovoltaic power plant and/or a wind turbine power plant.

11. The process according to claim 1, further comprising:
(k) storing part of the electrical energy produced by said renewable energy source in an electric storage battery; and
(l) producing said second hydrogen portion with electricity stored in said electric storage battery, when said renewable energy source is fully or partially unavailable.

12. The process according to claim 1, wherein the renewable energy source is or comprises a biomass, said hydrogen being produced in step c) by a step of conversion of said biomass to a hydrogen-containing gas with a thermochemical process, followed by a step of purification of said hydrogen-containing gas.

13. The process according to claim 1, wherein a part of the hydrogen produced in step (c) is sent to the hydrogen storage by means of a hydrogen compressor, hydrogen stored in the hydrogen storage feeding a suction side of the hydrogen compressor so that such compressor maintains desired pressure values in the hydrogen storage and feeds hydrogen to be contained in the ammonia make-up gas.

14. The process according to claim 1, wherein said hydrogen storage is maintained at a pressure of at least 50 bar.

15. The process according to a claim 1, wherein said hydrogen storage has a maximum capacity of 1-week average production, hydrogen produced in step (c).

16. The process according to claim 1, wherein said hydrogen produced with renewable energy accounts for up to 50% of the hydrogen contained in the ammonia make-up gas.

17. The process according to 1, wherein said reforming process includes reforming a hydrocarbon source and purification of the so obtained reformed gas, thereby obtaining said ammonia make-up gas; feeding the ammonia make-up gas to said ammonia converter via a compressor said hydrogen produced in step (c) being fed to the ammonia converter via that same compressor; wherein optional additional nitrogen is fed to the ammonia converter via one or more dedicated compressor(s) or via an air compressor and then through main compressor.

18. A method for revamping a plant for the synthesis of ammonia, wherein said plant includes:
a reforming front-end for the generation of an ammonia make-up gas by reforming a hydrocarbon source;
an ammonia synthesis loop including an ammonia converter;
said method comprising:
(I) providing a green hydrogen producer device, such as a water electrolyser, using a renewable energy source and a line arranged to feed green hydrogen from said green hydrogen producer device to the ammonia converter under pressure;
(II) providing a hydrogen storage, an input line arranged to feed the green hydrogen to the hydrogen storage and an output line arranged to feed hydrogen from said hydrogen storage to the ammonia converter;
(III) updating a process management system of said plant for implementing the process according to any of the preceding claims;
wherein step (III) comprises uploading a computer program in an internal memory of the process management system of said plant; said computer program comprising software code portions suitable for implementing said process, wherein said software code portions are executed by said process management system.
